(19) United States
(12) Patent Application Publication
(10) Pub. No.: US 2017/0082214 A1
(43) Pub. Date: Mar. 23, 2017

(54) FLOW VALVE APPARATUS

(71) Applicant: COMMONWEALTH OILFIELD PRODUCTS, LLC, Houston, TX (US)

(72) Inventors: Andrew HODGKINSON, Spring, TX (US); Stephen John MCLOUGHLIN, Apse Heath (GB)

(73) Assignee: COMMONWEALTH OILFIELD PRODUCTS, LLC

(21) Appl. No.: 14/860,675

(22) Filed: Sep. 21, 2015

(51) Int. Cl. F16K 31/22; F16K 1/14; E21B 21/10

(52) U.S. Cl. CPC F16K 31/22; E21B 21/10; F16K 1/14

(57) ABSTRACT

The flow valve apparatus includes a valve body, a valve sub assembly, a valve stem guide, and a spring. The valve body can be placed in a pipeline or other fluid flow path. The valve sub assembly has a float and valve stem to control flow through the valve body. Actuating the float between a first position at a proximal end and a second position at a distal end opens and closes the flow valve apparatus. The valve body has an outer surface and an inner surface. The inner surface has a stem chamber and a float chamber. The valve sub assembly is oriented so that the float is positioned in the float chamber and the valve stem is positioned in the stem chamber. The cross-sectional area formed by the inner surface and the float is constant, when the float is in the first position.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to an apparatus for controlling fluid flow. More particularly, the present invention relates to a flow valve. Even more particularly, the present invention relates to a flow valve that is resistant to turbulence and wear, conferring greater serviceability and longevity.

2. Description of Related Art Including Information Disclosed Under 37 CFR 1.97 and 37 CFR 1.98

Valves are known control mechanisms for opening and closing a flow of a fluid. A well known example of an early float valve can be found inside a toilet cistern, wherein a buoyant lever is actuated up and down by floating a ball cock on the water level inside the water tank of the toilet. The inlet valve remains open to fill the cistern with water, and the ball cock rises as the water level increases. The ball cock reaches a pre-set height so that the attached lever closes the inlet valve, thereby stopping the flow of water. A flush handle attached to a chain raises a flap in the bottom of the water tank, allowing water to drain and lowering the water level. In response the ball cock lowers along with the water level, so that the lever opens the inlet valve, so as to refill the water tank.

In drilling operations for oil production, float valves, flow valves, and check valves are also used to selectively open and close a flow path in the drilling string in response to the circulation of drilling fluids within the wellbore. When drilling a wellbore, drilling mud is circulated through the borehole and the drill string for the purposes of lubrication, heat dispersion, and removal of cuttings from the bottom of borehole. The cuttings are circulated out of the borehole for removal by providing fluid velocity which exceeds the cuttings ability to sink back to the bottom of the wellbore. “Clean” drilling mud is therefore pumped from the surface through the internal diameter of the drill string out through the jet nozzles located within the drill bit at the bottom of the borehole. “Dirty” drilling mud comprising a mixture of drilling mud and cuttings which are formed during the process of drilling the wellbore, is pumped back up the annulus between the drilling assembly tubulars and the borehole wall to the surface for disposal. The “dirty” drilling mud carrying the cuttings therefore is preferentially present only outside the drill string, whereas the “clean” drilling mud is present within the internal diameter of the drill string. This distinction between these two operating environments is important and is maintained by the presence of a valve.

In the process of rotary drilling, in order to continue deepening the wellbore, an additional length of threaded drill string must be attached at the surface, to the pipe which is already within the wellbore. In order for this to occur, pumping the clean drilling mud through the interior of the drill string must stop. The process of stopping the flow of drilling fluid can lead to a pressure imbalance between the higher density drilling fluid which is carrying cuttings in the wellbore annulus and the clean drilling fluid which is within the drill string, wherein the annular drilling mud which is carrying the cuttings back flushes into the interior of the drill string. The magnitude of the return flow within the drill string is largely proportionalal to the amount of cuttings being carried by the drilling fluid which is, in turn proportional to the rate of penetration. Back flushing is detrimental because the cuttings being carried by the drilling mud can result in the drill bit jet nozzles becoming plugged. If the nozzles become plugged, then, when the drilling fluid flow is re-established, the drilling fluid is unable to exit through the bit jets. This is operationally undesirable because, in the event of such an occurrence, drilling has to stop and the drill string has to be removed from the wellbore. The shortened drilling time is both practically and economically desirable. Furthermore, plugging the bit jets such that drilling fluid circulation cannot be re-established is functionally dangerous as the circulation cannot be re-established in the event of a well control incident and, additionally, the drilling assembly has to be tripped “wet”, which increases the physical risk to the drill crew. In summary therefore, allowing the drill-bit nozzles to become plugged is poor practice and carries significant environmental, safety and engineering penalties.

Conventional industrial valves are used for one way flow, preventing the backflush from a flowpath. The backflushing fluid can float a buoyant ball upward to close the flow. In other conventional flow valves, stopping flow of a pumped fluid triggers the valve to seal. The lack of pumped fluid removes the pressure so that the valve is sealed by spring action. These conventional valves are consumable items, which must be repeatedly replaced throughout a drilling operation.

In the past, various patents have been issued on innovations to valves. In particular, there are modifications of the flow channel around the ball float. U.S. Pat. No. 7,604,063, issued to Mashburn on Oct. 20, 2009, describes a valve chamber with an insert, so that the ball float moves within the chamber and along the insert with guiding legs. The guiding legs narrow the flow channel for sealing, while fluid flows past and through the guiding legs until the seal of the ball float. U.S. Pat. No. 5,144,049, issued to Covard on May 2, 1995, discloses a curved and conical flow channel for movement of the ball along the exterior surface of the flow channel. U.S. Pat. No. 3,385,372, issued to Knox on May 28, 1968, shows a main body with a contoured inner surface and a ball float travelling through the main body. The flow channel is shown as cylindrical to conical shaped, similar to the other patents.

U.S. Pat. No. 4,687,019, issued to Mayfield on Aug. 18, 1987, describes a double cone shape of the internal chamber with a curved ball seat at the end. The conventional prior art routinely show combinations of cylinders and cones to narrow the flow channel until the ball of the float valve seals the flow as the flow channel is narrowed. The ball become friction fit against the end of the flow channel so that the ball cannot move through the flow channel, preventing fluid from passing through the flow channel.

Prior art in the field of the oil and gas industry, despite its several iterations and improvements has failed to answer the specific problem caused by intra valve erosion. The economic implications of this problem has become more evident in recent years as the depth of the wellbore and the operational drilling parameters which are used to drill the wellbore have increased. For example, historically it was accepted that drilling an 8½″ diameter hole section with flow rates of as low as 400-450 GPM was adequate. More recently, however the range of acceptable flow rates would more probably be from 600-650 GPM. The resultant increase in flow creates additional opportunities for intra-valve erosion. Additionally, as wells have become deeper, the financial penalties created by lost productivity resulting from premature tripping out of hole with a drilling assembly have, likewise, increased.

Furthermore, the type of drill bits has altered over time. Whereas, historically the majority of drill bits were tri-cone rock bits which typically had three jet nozzles of variable diameter, more recently poly crystalline compact (“PDC”) shear bits are more commonly utilized. These bits may have as many as 10 or 12 bit jets. Therefore, although the total flow area (“TFA”) of the bit jets may be comparable, the size of each jet nozzle is smaller, providing more opportunities for them to be plugged with drill bit cuttings in the event of back-flow from the annulus into the internal diameter of the drilling assembly.

The present invention improves over existing art in the field as it provides solutions for the aforementioned problems.

It is therefore an object of the present invention to provide an embodiment of a flow valve apparatus to control fluid flow through a drill string.

It is an object of the present invention to provide an embodiment of a flow valve apparatus to prevent back flushing between annulus and the internal diameter of the drillstring.

It is an object of the present invention to provide a flow valve apparatus operating at higher flow rates without reducing operating life. It is another object of the present invention to provide an embodiment of a flow valve apparatus with a longer operational life span.

It is another object of the present invention to provide an embodiment of a flow valve apparatus resistant to wear, abrasion, erosion and attrition from intra-valve turbulence created by the fluid flow.

It is still another object of the present invention to provide an embodiment of a flow valve apparatus with a flow channel having a constant flow cross-section, when a float is in the open position.

It is still another object of the present invention to provide an embodiment of a flow valve apparatus with a flow channel compatible to the shape of the float.

It is yet another object of the present invention to provide an embodiment of a flow valve apparatus with a flow channel with curved walls to form a constant cross-section when a spherical ball float is positioned such that the valve is in the open position.

It is yet another object of the present invention to provide an embodiment of a flow valve apparatus with a flow channel with walls maintaining a constant distance from the float, when the float is in the open position.

These and other objectives and advantages of the present invention will become apparent from a reading of the attached specifications and appended claims.

### SUMMARY OF THE INVENTION

Embodiments of the flow valve apparatus of the present invention include a valve body, a valve stem guide, a spring means and a valve sub assembly. The valve body is incorporated into a system containing flowing fluids, such as a pipeline or drilling assembly. The valve sub assembly has a float and a valve stem. The valve sub assembly can have reciprocating motion in response to fluid flow within the pipeline or drilling assembly. The float is mounted on an end of the valve stem. The valve sub assembly therefore controls the fluid flow through the valve body. The valve sub assembly is moveable with respect to the valve body between an open position and a closed position. The valve body has an outer surface and an inner surface. The outer surface includes a sealing means for engaging the internal diameter of a pipeline or fluid carrying tubular system such as a drilling assembly. The sealing means can be a seal ring seated in a seal recess on the outer surface of the valve body. When the valve sub assembly is in the closed position, the inner surface of the valve body engages the float, effectively forming a seal between the valve body and the valve sub assembly. The valve body is further divided into a stem chamber and a float chamber. The stem chamber retains the valve stem of the valve sub assembly and the float chamber retains the float of the valve sub assembly. The float moves within the float chamber of the valve body. In some embodiments, the spring means engages the valve sub assembly and controls the limited translational movement of the valve sub assembly within the valve body. The spring means can be mounted around the valve stem of the valve sub assembly. The valve stem guide fits into the stem chamber of the valve body. A seal groove and groove ring on the exterior of the sleeve engages the stem chamber in one embodiment. Alternatively, there can also be threaded engagement of the valve stem guide and the stem chamber in other embodiments. The valve stem guide seals to the valve body. The fluid tight connection of the valve stem guide and the stem chamber of the valve body can be friction fit, snap fit or threaded fit.

The present invention includes a float chamber of the valve body having an internal diameter, a proximal end, and a distal end. The float of the valve sub assembly is positioned within the float chamber of the valve body and moves axially with a limited range of motion between the proximal end of the float chamber of the valve body and the distal end of float chamber of the valve chamber. The float has a first position, wherein the valve sub assembly is seated at the proximal end of the float chamber of the valve body thereby forming an effective seal against fluid pressure so as to prevent fluid from passing across the valve body. The float also has a second position, wherein the valve sub assembly is moved within the float chamber of the valve body toward a distal end. The second position opens the valve body to allow fluid flow through the valve body, and consequently, the pipeline.

In embodiments of the present invention, when the valve sub assembly is in the second position, the cross-sectional area between the inner surface of the float chamber of the valve body and a surface of the float of the valve sub assembly remains constant. Therefore, when the float is in the second position within the valve chamber, the annular space between the valve body and the valve sub assembly forms a fluid path through the valve body reducing intra-valve turbulence and minimizing wear on the float of the valve sub assembly and surfaces of the float chamber and stem chamber of the valve body. The annular space is therefore a constant cross sectional area, whereby the exterior of the float of the valve sub assembly is not subjected to uneven flow when in the open position. The exterior of the float of the valve sub assembly is not subjected to any flow in the closed or first position: the valve body is sealed in the closed position. In some embodiments, therefore, the float maintains a constant distance to the float chamber of the valve body. The inner surface of the float chamber of the valve body is profiled with contours complementary to the outer surface of the float of the valve sub assembly. The profile of the internal diameter of the float chamber of the valve body is therefore compatible with the dimensional profile and attributes of the float of the valve sub assembly. The internal diameter of the valve body may therefore be varied, according to the dimensional attributes of the float. If the float is curved, then the inner surface of the float chamber of the valve body has a radius of curvature corresponding to a radius of curvature of the float in order to maintain a constant cross-sectional area between float and float valve body. The cross-section of the flow path through the valve body remains constant whatever the position of the float within the float chamber of the valve body in the second or open position.

In some embodiments, the valve sub assembly comprises a float and a valve stem with the valve stem engaging the valve stem guide. The float moves between the proximal end of the float chamber of the valve body and the distal end of the float chamber of the valve body, while the valve stem retracts and extends cooperatively within a central shaft of the valve stem guide. The first position corresponds to the float positioned at the proximal end of the float chamber and the valve stem extended from the central shaft of the valve stem guide. The second position therefore corresponds to the float being positioned at the distal end of the float chamber and the valve stem being retracted and housed within into the central shaft of the valve stem guide. An embodiment of the flow valve apparatus includes the valve stem guide and spring means. The valve stem guide can include a central shaft, a sleeve, and at least one rib supporting the central shaft within the sleeve. The valve stem of the valve sub assembly can be removably inserted into the central shaft through the spring means. The spring means is also contained by the central shaft. A shoulder in the central shaft abuts one end of the spring means and capturing the spring. The other end of the spring means engages the float of the valve sub assembly. The spring means is extended in the first position when the valve sub assembly seals to the valve body. The spring means is compressed in the second position when there is fluid flow through the valve body. The sleeve of the valve stem guide can be mounted in the stem chamber of the valve body. The sleeve is removably retained in the stem chamber by a friction fit, snap fit or threaded engagement, as desired. An exterior of the sleeve engages the stem chamber of the valve body.

In embodiments with a stem chamber of the valve body, the sleeve of the valve stem guide has an outer diameter engaging the inner surface of the stem chamber. The sleeve is comprised of a seal groove on the outer diameter of the sleeve and a seal ring housed in the seal groove. The seal groove and seal ring retain the sleeve of the valve stem guide to the stem chamber of the valve body. In other embodiments, there can also be threads on the outer diameter of the sleeve and complementary threads on the inner surface of the stem chamber of the valve body. Alternatively, there can be sealed and threaded engagement of the valve stem guide to the valve body. The valve stem guide is aligned within the stem chamber, and the float of the valve sub assembly is aligned within the float chamber.

The embodiments of the method for controlling fluid flow with the flow valve apparatus of the present invention include the steps of setting the valve sub assembly within the valve body, wherein the float is positioned within the float chamber and the valve stem is located within the stem chamber, assembling the flow valve apparatus in a pipeline, initiating fluid flow through the pipeline to actuate the valve sub assembly from the first position to the second position, initiating flow as a part of, for example, the drilling process and flowing fluid through a cross sectional area formed between the valve sub assembly and the valve body. The valve sub assembly actuates between a first position and a second position relative to pressure of fluid flow against the valve sub assembly and the spring is compressed as a result of the hydraulic force of the fluid flowing against the valve sub assembly. In the second position, fluid flows through a constant cross sectional area between the float of the valve sub-assembly and the float chamber of the valve body. The spring engaged to the valve sub assembly is compressed by the pressure of fluid flow. In the first position, the float of the valve sub assembly seals the valve body. Without the pressure of the fluid flow, the spring expands to return the valve sub assembly from the second position to the first position.

The method also includes decreasing flow pressure against the valve sub assembly so that the float returns to the first position. The force of the spring means returns to the closed position. The float contacts the inner surface, so that the cross-sectional area at the proximal end of the valve chamber is zero, and there is no flow. The flow control can actuate back and forth by force exert by the spring means and force exerted by fluid flow. There is no induced valve chatter when the valve sub assembly is moving from the second, open, position to the first, closed position.

### BRIEF DESCRIPTION OF THE DRAWINGS

FIG. 1 is a longitudinal cross-sectional view of an embodiment of the flow valve apparatus, according to the present invention, showing the float in the first position.

FIG. 2 is front perspective view and partial sectional view of the embodiment of the flow valve apparatus of FIG. 1.

FIG. 3 is rear perspective view and partial sectional view of the embodiment of the flow valve apparatus of FIG. 1.

FIG. 4 is another longitudinal cross-sectional view of an embodiment of the flow valve apparatus, according to the present invention, showing the float in the second position.

### DETAILED DESCRIPTION OF THE DRAWINGS

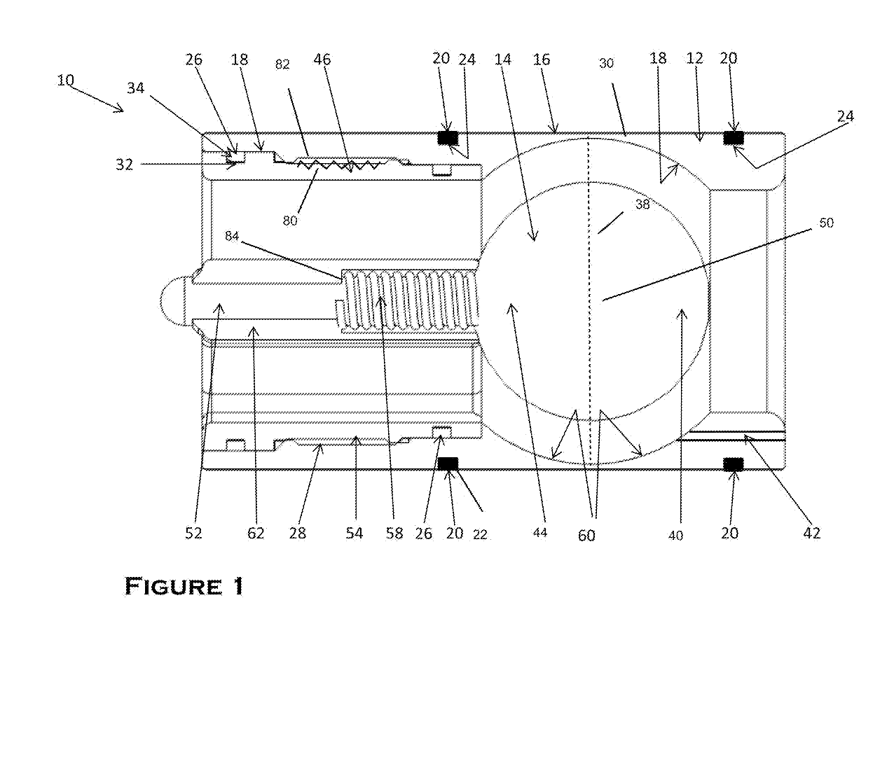

Referring to FIGS. 1-4, the embodiments of the present invention show a flow valve apparatus 10 for controlling fluid flow, such as fluid flow through a tubular pipeline. The flow valve apparatus 10 includes a valve body 12, a valve sub assembly 14, a spring means 58, and a valve stem guide 46. The valve body 12 has an outer surface 16 and an inner surface 18. The outer surface 16 is cooperatively inserted within a fluid flow tubular, such as a pipeline or drilling assembly. In FIGS. 1-3, the outer surface 16 is shown with a sealing means 20. The embodiment includes the sealing means 20 comprising a seal ring 22 and a recess 24 circumferentially configured about the outer surface 16 of the valve body 12. The seal ring 22 fits into the recess 24 so that the seal ring 22 forms a fluid-tight seal within the pipeline. The seal ring 22 creates an outer sealing surface to engage the interior of the pipeline or other structure whereby the fluid flow of the pipeline is securely directed through the flow valve apparatus 10. There is no passage for fluid to flow around the valve body 12. The fluid flow must pass through the valve body 12.

The embodiments of the present invention show the inner surface 18 of the valve body 12 engaging the valve sub assembly 14 in a sealed relationship. FIGS. 1-4 illustrate the float valve body 12 being comprised of a float chamber 30 and a stem chamber 28. The float chamber 28 has an internal diameter 38, a proximal end 44, and a distal end 40. The valve sub assembly 14 has a float 50 and a valve stem 52. The valve stem 52 is housed in the stem chamber 28, and the float 50 is housed in the float chamber 30. The float 50 is moveable within the float chamber 30 between the first position at the proximal end 40 and the second position at the distal end 44. The float 50 at the proximal end 44 opens flow through the valve body, and the float 50 at the distal end 40 seals the valve body 12, preventing fluid from further entry to the pipeline tubular.

FIGS. 1-4 also show the valve stem guide 46. The valve stem guide 46 is also mounted in the stem chamber 28. The valve stem guide 46 is comprised of a sleeve 54, a central shaft 62, and a rib 56. The rib 56 extends inward from the sleeve 54. The rib 56 supports the central shaft 62 in the middle of the sleeve 54. The valve stem 52 of the valve sub assembly 14 inserts into the central shaft 62 so as to guide translational movement of the float 50 at the end of the valve stem 52. The limited movement of the float 50 within the float chamber 30 is controlled by the valve stem guide 46.

The figures also show the connection of the valve stem guide 46 to the stem chamber 28 of the valve body 12. In one embodiment, the sleeve 54 has an attachment means 26 comprised of a seal groove 32 and a groove ring 34 to cooperatively engage and retain the valve stem guide 46 within the valve body 12. In this embodiment, the seal groove 32 is circumferentially located about an exterior of the sleeve 54, and groove ring 32 friction fits in the seal groove 34. An outer sealing surface on the groove ring 32 engages the inner surface 18 of the valve body 12 adjacent to the stem chamber 28 to maintain position of the valve stem guide 46 relative to the valve body 12. Thus, the valve sub assembly 14 and the spring means 58 are also generally held in place relative to the valve body 12. In another embodiment, as illustrated in FIG. 1, a portion of the sleeve 54 can have an attachment means 26 comprised of a threaded portion 80 circumferentially machined into the exterior of the sleeve 54 and complementary threaded portion 82 on the stem chamber 28 of the valve body 12. The threaded engagement of the threaded portion 80 and complementary threaded portion 82 can connect to the valve stem guide 46 and the valve body 12. Other attachment means can be used to hold the valve stem guide 46 to the valve body 12 and the attachment means 26 can be placed in other locations than those illustrated in the Figures. When the valve is in the second, open position, fluid flows through the sleeve 54 of the valve stem guide 46 and around the central shaft 62 and the rib 56. The attachment means 26 prevents fluid from entering the interstitial space between the outer diameter of the valve stem guide 46 and the internal surface 18 of the stem chamber 28. For purposes of clarity, the seal is not shown in the illustration, but two possible attachment means are shown in FIG. 1. Fluid also flows around the valve sub assembly 14 being held in position by the central shaft 62.

The spring means 58 is set between the valve stem guide 46 and the valve sub assembly 14. The spring means 58 can be circumferentially co-located about the valve stem 52 and within the central shaft 62 of the valve stem guide 46. The spring means 58 can be a compression spring, such as a coiled compression spring. In FIGS. 1-3, the embodiments show a shoulder 84 within the central shaft 62. The spring means 58 abuts against the shoulder 84 on one end and engages the valve sub assembly 14 at the other end. The abutment allows the spring means 58 to exert a restoring force against the valve sub assembly 14. In the absence of any positive proximal flow in the tubular, the spring means 58 moves the float 50 to the closed position. The Figures show one end of the spring means 58 being positively engaged to the float 50 of the valve sub assembly 14.

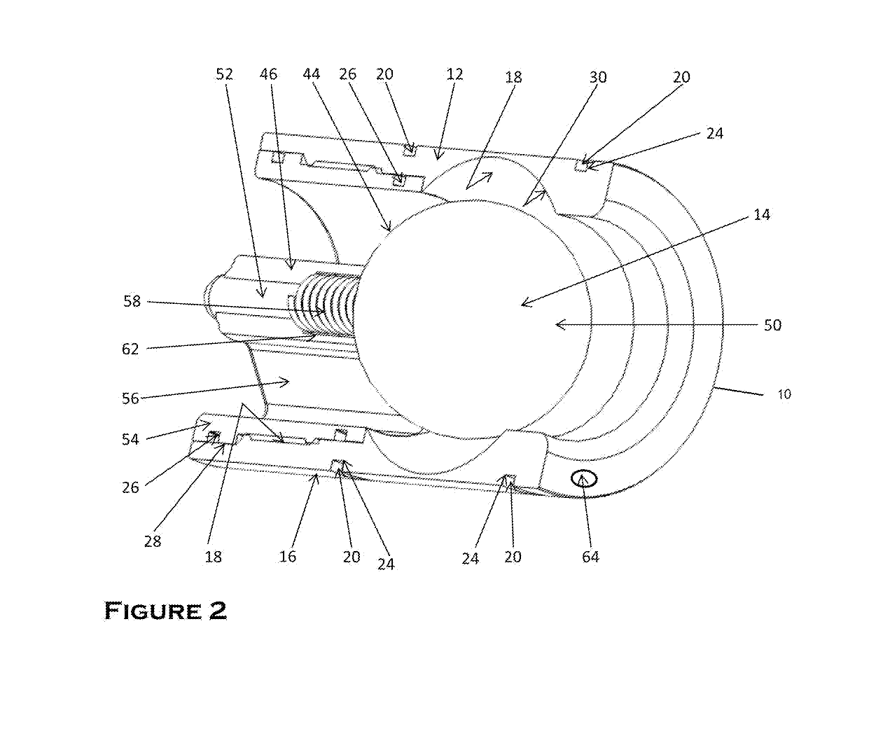

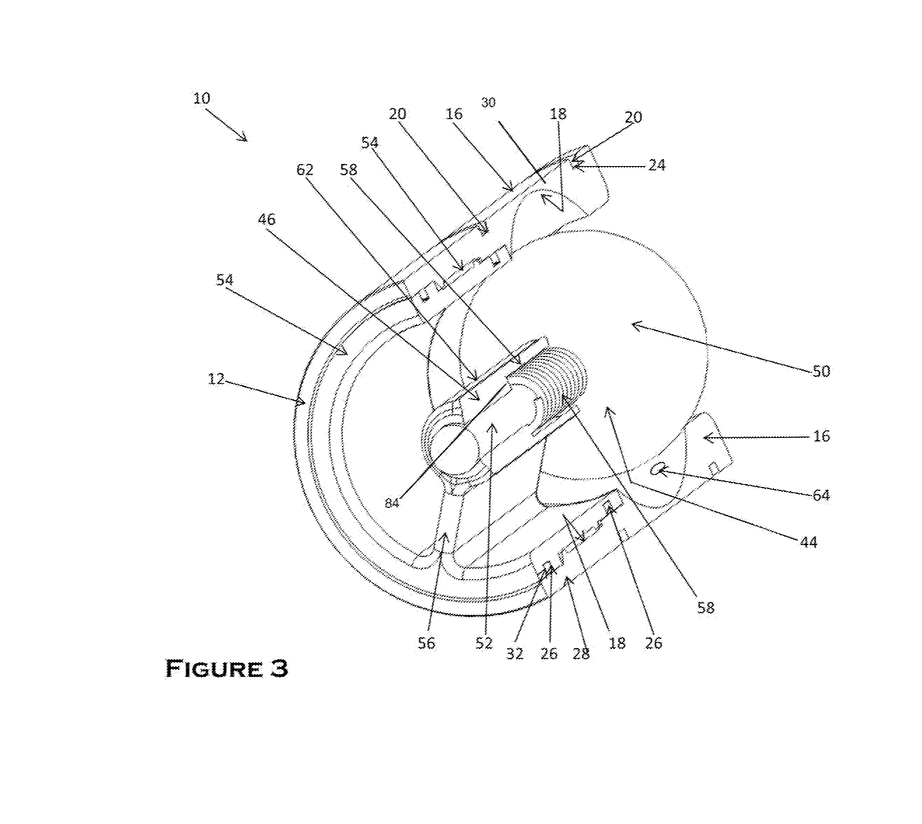

FIGS. 2-3 show a bypass port 64 bored through the valve body 12. The bypass port 64 allows monitoring of the pressure in the drillstring below the flow valve apparatus 10. This monitoring is invaluable in well control operations.

FIGS. 1-4 show embodiments of the first position and second position of the float 50 of the valve sub assembly 14 whereby flow is controlled through the valve body 12. The float 50 is positioned within the float chamber 30, and the valve stem 52 is positioned within the stem chamber 28, along with the valve stem guide 46. The float 50 is moveable between the proximal end 44 and the distal end 42 of the float chamber 30. The float 50 in the first position is a closed position for fluid flow through the valve body 12. The float 50 in the second position is an open position with the valve body 12 being open to positive fluid flow from a proximal direction. The first position corresponds to the valve stem 52 being extended upon the central shaft 62 and the spring means 58 being in an un-compressed state. The valve body 12 is closed against flow from a distal direction. The second position which derives from positive proximal flow within the pipeline, corresponds to the valve stem 52 being retracted within the central shaft 62 toward the distal end 40 of the valve chamber 30 of the valve body 12, and the spring means 58 being in a compressed state. The float 50 engages the distal end 40 of the float chamber 30, sealing the valve body 12.

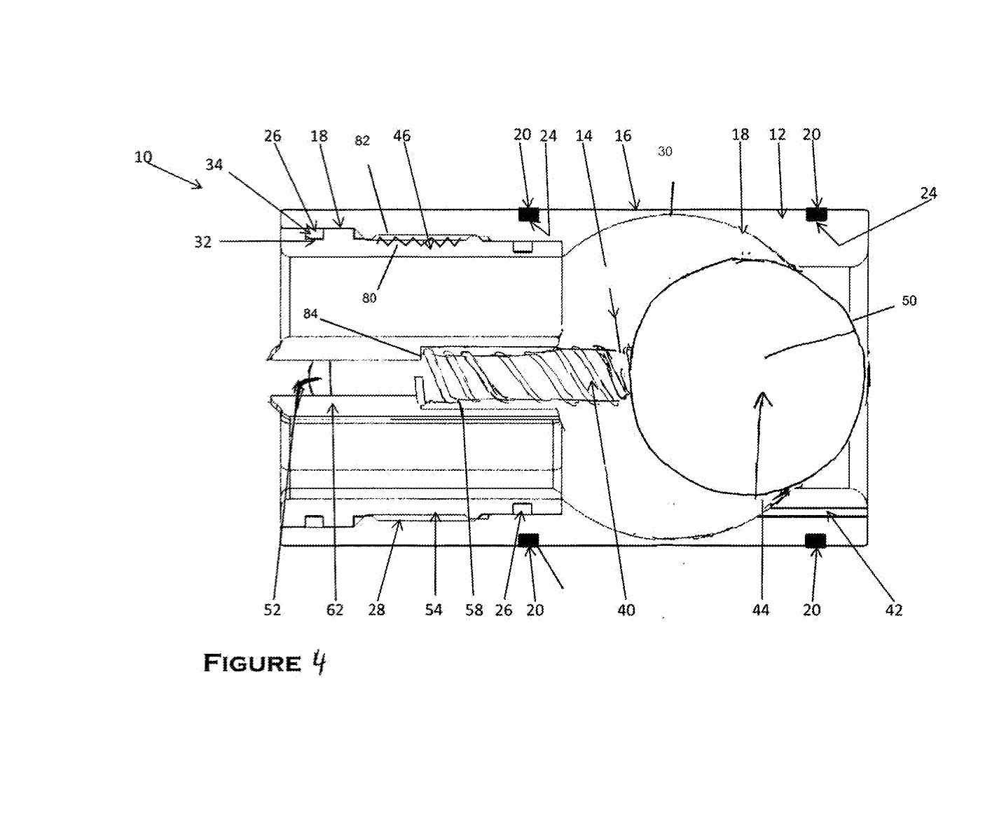

FIGS. 1-3 therefore show the valve sub assembly 14 in the second position with open flow. FIG. 4 shows the valve sub assembly 14 in the second position. In FIG. 4, return flow from the wellbore annulus is prevented because the valve body 12 is closed by the float 50. The second position corresponds to an open position, with the valve body 12 allowing fluid to flow in from the proximal end 44 with passage there through to the distal end 40, generally in response to fluid being pumped from the surface of the earth to the drill bit. Hydraulic force overcomes the resistance of the spring means 58, such as a die-spring assembly, and the residual hydraulic forces being generated by imbalances between annular and internal pipe pressures. FIGS. 1-3 show the first position where the float 50 is no longer in contact with the quasi-hemispherically formed sealing inner surface 18 of the valve body 12. FIG. 4 shows the float 50 at the first position with the float 50 being extended by the spring means 58 so as to cooperatively engage the proximally located quasi-hemispherical sealing surface 18 of the valve body 12. FIGS. 1-4 show all embodiments with the cross-sectional flow area 60 formed by the inner surface 18 of the float chamber 30 of the valve body 12 and the float 50 as a constant, when the float 44 is the second position relative to the float chamber 30. The cross-sectional area 60 forms a fluid path through the valve body 12. Between the inner surface 18 and float 50 of the present invention, the fluid flow is therefore constant and not subject to turbulence. In prior art, the format of both the valves and the valve chambers reduced the effective cross-sectional area at various points within the flow valve. Therefore, with an intermittently variable opening and resultant variable cross sectional area, the fluid flow was uneven. Variations in acceleration of the fluid caused turbulence and variations in flow velocity, particularly in the vicinity of the stem guides, therefore caused increased and accelerated wear and damage to the valve sub assembly. The situation was further exacerbated by the presence of solids in the drilling mud and occasionally by residual cuttings which served to accelerate the detrimental processes of erosion, abrasion and attrition. Abrasive damage reduces the sealing capacity of the float within the valve body. Furthermore, in prior art, erosion of the valve stem resulted in additional instability of the float valve within the valve body. This, in turn, created geometric imbalance within the float which further served to increase the rate of erosion of the valve surfaces and accelerated the reduction in valve lifespan. Therefore, the prior art flow valves had short working life spans, and the costs and time for frequent replacement compromised the efficiency of the drilling assembly string or pipeline, which had significant economic implications.

In a significant improvement over prior art, the present invention, the embodiments have the float 50 maintaining a constant cross sectional area between the inner surface 18 of the float chamber 30, and the float 50, when the float 50 is in the second position. The profile of the inner surface 18 of the float chamber 30 is compatible with the profile of the float 50. The contour of the inner surface 18 is complementary to the surface of the float 50 as the float travels within the float chamber 30. The internal diameter 38 of the inner surface 18 of the valve body 12 is variable, and compatible with the shape of the float 50, providing for a constant cross-sectional area 60. The distance 60 between inner surface 18 at the float chamber 30 and the surface of the float 50 can also be generally constant. The area of the flow path is therefore free from alterations in cross sectional area and the turbulence and accelerated erosion which was a feature of prior art is avoided. In order to maintain the constant cross sectional area, the total flow path area remains enlarged, and therefore the float 50 is not subjected to extra fluid accelerations which may lead to increased turbulent flow and undesirable erosive forces.

Embodiments of FIGS. 1-4 show the float 50 as spherical: the corresponding inner surface 18 of the float chamber 30 has a radius of curvature with a cooperatively formed hemispherical profile. The cross-section of the flow path around the float 50 through the valve body 12 therefore remains constant as the float 50 sets in the second position within the float chamber 30. The constant cross-sectional area reduces turbulence in the fluid flow so that the valve apparatus 10 has a longer working life. The valve body 12 and valve sub assembly 14 thereby resist wear and remain functional for longer periods of time.

In a particular embodiment, the float 50 is a ball member as illustrated in exemplary FIGS. 1-4. The stem shaft 52 engages the valve stem guide 46, and the valve stem guide 46 engages the valve body 12 within the stem chamber 28. The ball member is the moveable element of the float 50, which is fully exposed to the fluid flowing through the valve body 12 as the ball member moves between a closed position at the proximal end 44 of the float chamber 30 and an open position whereby the ball member is located at the distal end 40 of the float chamber 30. Also in FIGS. 1-3, the embodiment of the valve stem guide 46 comprises a hollow tubular sleeve 54, which is attached to a centrally located shaft or tubular member 62 by means of at least one rib or guide 56. Located within the shaft or tubular member 62 is a spring 58 which provides closure means to return the valve sub assembly 14 to a closed position. The sleeve 54 of the valve stem guide 46 in the embodiment is equipped with an attachment means 26 for retention within the distally located stem chamber 28 of the valve body 12. The sleeve 54 is retained within the stem chamber 28 by the attachment means 26, although other means may be employed as desired without departing from the spirit of the invention. The sleeve 54 is thereby removably engaged within the stem chamber 28. The rib 56 is made integral with the sleeve 54 and extends inward from the sleeve 54. FIGS. 2 and 3 shows the rib 56 configured as, at a minimum, a single rib extending inward from the sleeve 54 and forming a connection between the central shaft 62 and the sleeve 54. The valve stem guide 46 therefore comprises a central shaft tubular member 62, with the valve stem 52 being housed within the central shaft 62. The valve stem 52 is encompassed by the spring 58. FIG. 4 shows the spring 58 located about the valve stem 52 within the central shaft 62 at the end of the rib 56. The limits imposed by the compression limits of the spring 58 correspond to a first position and a second position of the float 50. An extended spring 58 maintains the float 50 in a first position within the valve body 12 and a compressed spring 58 keeps the float 50 in the second position. The retentive force of the spring 58 maintains the seal between the float 50 and the proximal sealing face of the inner surface 18 of the float chamber 30. Additional closure means is provided by annular back pressure which is applied to the distal face of the float 50, thereby compounding the effectiveness of the seal and assisting in the prevention of valve chatter. When fluid flows through the pipeline or drill string, the spring 58 is compressed in response to fluid pressure applied to the proximal end 44 of the float 50, whereby a fluid path of constant cross section is opened between the float chamber 30 and the stem chamber 28, allowing fluid to pass therethrough. When fluid flows through the pipeline or drill string, in response to pressure exerted on the proximal surface of the float 50, the spring 58 compresses and the co-located valve stem 52 moves from being extended within the central shaft 62 to a position of compression within the central shaft 62. When the float 50 comprising a ball member and a valve stem 52, is in the second, open, position, the ball member maintains a constant diametrical separation between the inner surface 18 of the valve body 12, and the ball member. As the diametrical separation is a constant distance 60, the cross-sectional area is also constant. The profile of the inner surface 18 is therefore compatible with the profile of the ball member. The contour of the inner surface 18 is complementary to the ball member as the chamber of the float 50 traverses the valve body 12.

The internal diameter 38 of the inner surface 18 of the valve body 12 is variable corresponding to the shape of the float 50. FIGS. 1-4 show the ball member as spherical, so the corresponding inner surface 18 has a radius of curvature configured to deliver a constant dimensional clearance between the ball member, whatever the second position of the float 50 within the float chamber 30. The cross-sectional area of the flow path through the valve body 12 therefore remains constant as the ball member of the float 50 is set in the second position within the float chamber 30. The constant cross-section allows for the float 50 to be positioned at various points within the float chamber 30 of the valve body 12, in response to variations in the flow rate which are introduced into the tubular from a proximal direction, thereby reducing turbulence in the flow so that the flow valve apparatus 10 has a longer working life. The valve body 12 and valve sub assembly 14 therefore resist wear and remain functional for longer periods of time.

Embodiments also include the method of controlling fluid flow with the flow valve apparatus of the present invention. The valve sub assembly 14 is first set within the valve body 12, with the float 50 positioned proximally within the float chamber 30 and the valve stem 52 positioned in the stem chamber 28. Subsequently, the valve body is assembled in a pipeline with fluid flow, for example as in a drill string with drilling mud. Fluid flow is initiated to exert fluid pressure against the float 50. The float 50 moves from the first position to the second position, corresponding to open when fluid is flowing. Fluid flows through the cross-sectional area formed between the inner surface 18 of the valve body 12 and the float 50, when the float is in the second position. When the float is in the first position to start, the proximal face of the float 50 is in contact with the proximal end of the float chamber 30, sealing the valve body 12. When fluid is flowing from a proximal direction to a distal direction, the cross-sectional area between the inner surface 18 of the float chamber 30 and the float 50 is constant, so the flow remains laminar while passing around the float 50 thereby removing the turbulence in flow which existed in prior art. When the float 50 is generally spherical, the inner surface 18 of the float chamber 30 has a radius of curvature cooperative with the float 50 which maintains the constant flow path.

The step of assembling the valve sub assembly 14 in the valve body 12 includes setting the valve stem guide 46 in the stem chamber 28 of the valve body 12. As illustrated, retention of the valve stem guide 46 within the stem chamber 28 is by an attachment means 26. In one embodiment, the attachment means 26 is a seal groove 32 and a seal ring 34. The seal groove 32 circumscribes the exterior of the sleeve 54 of the valve stem guide 46. The seal ring 34 fits in the seal groove 32 for a friction fit seal against the stem chamber 28 of the valve body 12. In another embodiment, the attachment means is a threaded portion 80 around the exterior of the sleeve 54. Complementary threads 82 on the stem chamber 28 engage the threaded portion 80 of the sleeve 54. The threaded engagement seals the valve stem guide 46 to the valve body 12. Preference is given to ACME stub type threads or other threaded means where the threads have a square profile, which have been shown to be less susceptible to binding when in contact with desiccated drilling fluids. Other attachment means are also possible and within the spirit of the invention. It is important to seal the interstitial space formed between the outer diameter of the valve stem guide 46 and the internal diameter of the stem chamber 28 within the valve body 12 in order to facilitate servicing of the device without having to remove consolidated drilling fluids.

There is a comparable outer sealing means 20 for assembling and sealing the valve body 12 within a pipeline tubular. The sealing means 20 comprises a seal ring 22, co-located within a seal recess 24 located on the outer circumferential surface 16 of the valve body 12. In order to prevent fluid bypassing the outer diameter 16 of the valve body 12, and in order to create an effective seal between the pipeline or drill string, the sealing means 20 on the outer surface 16 of the valve body 12 therefore comprises a seal recess 24 and a seal ring 22, wherein the seal ring 22 cooperatively fits within the seal recess 24 thereby forming an outer sealing surface with which to positively engage the pipeline or drill string, and forming an impermeable seal between valve body 12 and the internal diameter of the tubular.

The embodiment of the method includes increasing fluid pressure against the float 50 so as to move the float 50 from a closed first position to the open second position, thereby allowing fluid to pass through the valve body from a proximal direction to a distal direction. Whenever pressure from the annulus, or from the distal element of the pipeline or drilling assembly exceeds the pressure exerted in the reverse direction, clean drilling mud stops flowing from the proximal end of the valve body to the distal end. The higher annular pressure exerts a force against the float 50 in a direction which is opposite to the direction of the flow of clean drilling mud. As the pressure exerted from the distal end of the float assembly 10 exceeds the pressure being exerted from the proximal end of the float assembly, the flow pressure against the distal face of the float 50 moves the float 50 from the second position to the first position at the proximal end. The movement of the float 50 within the valve body 12 is positively assisted by return spring 58. When the proximal face of the float 50 reaches the contoured inner surface 18 of the float chamber 30, the float 50 is sealed against further ingress of fluid from a distal direction. The float 50 contacts the inner surface 18, such that the cross-sectional area is effectively zero at the proximal end of the float chamber 30. The dirty drilling mud can therefore no longer pass through the valve body 12, thereby protecting the drill string from further ingress of fluids. This represents the float 50 at the first position.

A further embodiment of the method is to increase fluid pressure against the float valve 14 from the proximal end, after the step of sealing the float valve 14 against the float valve body 12. When clean drilling mud is pumped through the internal diameter of the drill string, and the internal pressure of the proximal element of the pipeline or drill string exceeds the distal pressure within the float 50 at the stem chamber 28, the float 50 translates within the float chamber 30 from a proximal position to a distal position. The fluid pressure of the clean drilling mud must therefore exceed the combined forces of both the residual pressure in the distal element of the drill string and the compression spring 58 in order to open a fluid path through the flow valve apparatus 10. When fluid pressure from the proximal element of the pipeline or drill string is reduced, the float 50 translates in the opposite direction, resulting in translation between the second position to the first position. The actuation float 50 of the valve sub assembly 14 is set by the spring 58 and varying pressure from the distal and proximal ends of the valve body controlled by fluid flow. The pressure from fluid flow or other downhole conditions coordinate the one way flow through the valve body from the float chamber to the stem chamber.

Embodiments of the present invention provide a flow valve apparatus controlling the passage of fluid through a pipeline, drill string, or other flow path. Within the drilling element of the oil and gas industry, the flow valve apparatus is used to prevent annular fluids from entering the drill string. Allowing the ingress of annular fluids which may carry significant volumes of rock-cuttings is detrimental to the drilling process. Furthermore, in the event of a well control issue, wherein hydrocarbons pressure exceeds the hydrostatic wellbore pressure, the presence of the flow valve in the drill string prevents migration of the hydrocarbons from a downhole location to the surface of the earth, within the drill string. This last feature is a significant safety benefit. Embodiments of the present invention provide superior resistance to abrasion, erosion and attrition resulting in a longer life span which therefore results in lower service costs and lower frequency of replacement. In prior art, intra-valve turbulence was caused by the variations between the cross-sectional area of the fluid flow path and the cross sectional profile of the flow valve. These variations resulted in unwanted alterations to flow velocity and created intra-valve turbulence. Even with drilling mud which has relatively low levels of solids, turbulence could therefore wear unevenly on the valve sub assembly. In particular, where prior art configured the valve assembly with flat or conical proximal faces, the outer circumferential edge of the float was prone to wear as the fluid velocity, working in conjunction with the angular profile of the proximal face of the float, served to generate significant turbulence within the valve body. The presence of solids within the drilling mud provided for additional abrasion, frequently resulting in erosion to both the float and the valve stem, and the valve body. In a conventional flow valve system, the float itself can be replaced; however, erosion to the valve body is irreparable and therefore requires replacement of the entire apparatus. This has significant economic implications. Therefore, in summary, prior art has a cylindrical valve chamber which does not have the constant diametrical clearance between the float and the internal surface of the valve body with which to create a laminar flow path. Furthermore, prior art discloses conical valve chambers, which exacerbate the tortuosity of the fluid pathway within the float, resulting in significant levels of intra-valve turbulence.

In contrast with prior art, the flow valve apparatus system of the present invention has a flow channel with a generally constant cross-sectional area, which allows for the passage of fluid when the ball float is in a retracted position. The inner surface of the float chamber of the valve body and ball member have compatible profiles with which to maintain the constant cross-sectional area. In a particular embodiment, the flow channel therefore has the float chamber of the valve body with curved walls configured to cooperatively accommodate a spherical ball float, thereby creating a constant distance between the inner surface of the valve body and the external surface of the ball member, when the ball member is in the second or retracted position. The resulting constant cross-sectional area maintains a laminar flow regime throughout the valve body.

The foregoing disclosure and description of the invention is illustrative and explanatory thereof. Various changes in the details of the illustrated structures, construction and method can be made without departing from the true spirit of the invention.

We claim:

1. A flow valve apparatus, comprising:
a valve body having an outer surface and an inner surface, said outer surface having a sealing means, said valve body being comprised of a stem chamber and a float chamber, said float chamber having an internal diameter, a proximal end, and a distal end;
a valve sub assembly being comprised of a valve stem and a float, said valve stem being housed in said stem chamber, said float being housed in said float chamber, said float being moveable between a first position at said proximal end of said float chamber of said valve body and a second position at said distal end of said float chamber of said valve body;
a valve stem guide mounted in said stem chamber of said valve body, said valve stem guide being comprised of a sleeve, a central shaft and a rib connecting said central shaft to said sleeve, said valve stem being inserted into said central shaft so as to guide movement of said float at an end of said valve stem; and
a spring means between said valve stem guide and said valve sub assembly, said spring means mounted around said valve stem of said valve sub assembly,
wherein a cross-sectional area formed between said inner surface of said float chamber of said valve body and said float of said valve sub assembly is constant, when said float is in said second position at said distal end of said float chamber, said cross-sectional area corresponding to a fluid path through said valve body.

2. The flow valve apparatus, according to claim 1, wherein a surface of said float maintains a constant distance to said inner surface of said float chamber of said valve body, when said float is in said second position within said float chamber.

3. The flow valve apparatus, according to claim 1, wherein said float chamber of said valve body has a profile compatible with a profile of said float.

4. The flow valve apparatus, according to claim 3, wherein said float is generally spherical, said inner surface of said float chamber of said valve body having a radius of curvature cooperative with said float.

5. The flow valve apparatus, according to claim 1, further comprising:
a sealing means comprised of a seal recess circumscribing said exterior surface of said valve body and a seal ring, said seal ring being fit into said seal recess.

6. The flow valve apparatus, according to claim 1, wherein said sleeve of said valve stem guide comprises an attachment means, said attachment means being comprised of seal groove and a groove ring, said seal groove circumscribing an exterior of said sleeve, said groove ring being friction fit to said groove, said groove ring forming a sealing surface to said inner surface of said stem chamber of said valve body.

7. The flow valve apparatus, according to claim 1, wherein said sleeve of said valve stem guide comprises an attachment means comprised of a threaded portion, said threaded portion circumscribing an exterior of said sleeve, wherein said stem chamber of said valve body is comprised of a complementary threaded portion, wherein said sleeve is in threaded engagement to said valve body.

8. The flow valve apparatus, according to claim 1, wherein said central shaft comprises a shoulder, said spring means abutting said shoulder, and wherein said rib extends radially inward from a circumference of said sleeve, said central shaft being mounted in a center of said stem chamber of said valve body.

9. The flow valve apparatus, according to claim 1, wherein said valve sub assembly is oriented with said float in said float chamber and said valve stem in said stem chamber, said first position being a closed position for preventing flow of fluid through said valve body, said second position being an opened position for flow of fluid through said valve body, wherein said first position corresponds to said valve stem being retracted within said central shaft, said spring means being in an extended state, and wherein said second position corresponds to said valve stem being retracted within said central shaft toward said distal end of said valve chamber of said valve body, said spring means being in a compressed state.

10. The flow valve apparatus, according to claim 1, wherein said spring means is made integral with said float of said valve sub assembly, said spring means actuating said float between said first position and second position according to spring configuration.

11. The flow valve apparatus, according to claim 10, wherein said central shaft comprises a shoulder, said spring means abutting said shoulder, said spring means having one end abutting said shoulder and an opposite end abutting said float of said valve sub assembly.

12. The flow valve apparatus, according to claim 11, wherein said spring means circumscribes said valve stem of said valve sub assembly within at least a portion of said central shaft.

13. The flow valve apparatus, according to claim 9, wherein said float is a ball member, said ball member being moveable between said first position and said second position.

14. The flow valve apparatus, according to claim 9, wherein said float is a ball member, said valve stem engaging said central shaft, said ball member being moveable between said proximal end of said float chamber and said distal end of said float chamber, and wherein said cross-sectional area formed by said inner surface of said float chamber and said float is determined by geometry of said ball member and corresponding geometry of said inner surface of said float chamber of said valve body.

15. The flow valve apparatus, according to claim 14, wherein a surface of said ball member maintains a constant separation between said inner surface of said float chamber of said valve body, when said float is in said second position.

16. The flow valve apparatus, according to claim 14, wherein said float chamber has a profile compatible with a profile of said ball member, and wherein said ball member is generally spherical, said inner surface at said float chamber of said valve body having a radius of curvature cooperative with said ball member.

17. A method of controlling fluid flow with a flow valve apparatus, according to claim 1, the method comprising the steps of:
setting said valve sub assembly within said valve body, said sleeve of said valve stem guide having an attachment means comprised of seal groove and a groove ring, said seal groove circumscribing an exterior of said sleeve, said groove ring being friction fit within said seal groove, said groove ring forming a sealing surface to said inner surface of said stem chamber of said valve body;
positioning said float in said float chamber of said valve body, said valve stem in said stem chamber of said valve body, wherein said float is in said first position corresponding to said proximal end of said float chamber of said valve body, said float of said valve sub assembly sealing against said valve body;
assembling said valve body in a pipeline with fluid flow, said outer surface having a sealing means comprised of a seal recess and a seal ring, said seal ring being fit cooperatively into said seal recess, said seal ring within said seal recess forming an outer sealing surface in engagement with an internal diametrical wall of said pipeline;
initiating fluid flow through said pipeline so as to exert fluid pressure against said float of said valve sub assembly, said fluid pressure moving said float from said first position to said second position; and
flowing fluid through a cross-sectional area formed by said inner surface of said float chamber and said float, said float being in said second position within said float chamber of said valve body.

18. The method for controlling flow, according to claim 17, wherein said float is generally spherical, said inner surface at said float chamber of said valve body having a radius of curvature cooperative with said float.

19. The method for controlling fluid flow, according to claim 17, further comprising the steps of:
decreasing flow pressure against said float, said spring means returning said float to said first position so as to seal said valve body.

20. The method for controlling fluid flow, according to claim 19, wherein said spring means is in a compressed state in said second position, and wherein said spring means is in an extended state in said first position.
